(19) United States
(12) Patent Application Publication
(10) Pub. No.: US 2006/0284928 A1
(43) Pub. Date: Dec. 21, 2006

(54) Inkjet image forming apparatus and image-shift printing method thereof

(75) Inventor: Jin-ho Park, Yongin-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/453,149

(22) Filed: Jun. 15, 2006

(30) Foreign Application Priority Data
Jun. 16, 2005 (KR) 2005-52039

(51) Int. Cl. B41J 2/155

(52) U.S. Cl. 347/42

(57) ABSTRACT

An inkjet image forming apparatus and an image-shift printing method thereof. The image-shift printing method of the inkjet image forming apparatus that includes a printhead having a nozzle unit corresponding to the width of a print medium and iteratively prints identical data on a plurality of print media, includes shifting a print image at least once in a width direction of the print medium and printing the print image on the print medium.

### CROSS-REFERENCE TO RELATED APPLICATIONS

This application claims the benefit under 35 U.S.C. § 119 of Korean Patent Application No. 2005-52039, filed on Jun. 16, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to an inkjet image forming apparatus to form an image by using different nozzles during iterative printing operations of identical data, and an image-shift printing method of the inkjet image forming apparatus.

2. Description of the Related Art

In general, an inkjet image forming apparatus forms images by ejecting ink from a printhead that reciprocates in a direction that is perpendicular to a transferring direction of a print medium. The inkjet image forming apparatus is referred to as a shuttle type inkjet image forming apparatus. A nozzle unit having a plurality of nozzles for ejecting ink is installed in the printhead of the shuttle-type inkjet image forming apparatus.

Recently, to achieve a high-speed printing, a printhead having a nozzle unit with a length corresponding to a width of the print medium has been developed. An image forming apparatus having such a printhead is referred to as a line printing type inkjet image forming apparatus. In the line printing type inkjet image forming apparatus, the printhead is fixed and only the print medium is transferred. Accordingly, each nozzle disposed in the printhead ejects ink onto a fixed area on the print medium.

FIG. 1 illustrates a specific printing pattern printed by a conventional inkjet image forming apparatus. When the specific printing pattern of FIG. 1 is iteratively printed on a print medium P, nozzles a1, a2, a3, a4, and a5 in a printhead 5 consequently eject a larger amount of ink onto the print medium P than other nozzles. Accordingly, since only the nozzles al, a2, a3, a4 and a5 are used for the iterative printing of the specific printing pattern, a lifetimes of the printhead is rapidly reduced.

According to a conventional method for a conventional inkjet image forming apparatus performing iterative printing described above, when a specific pattern is iteratively printed, only some nozzles are used, thereby reducing the lifetime of the printhead.

### SUMMARY OF THE INVENTION

The present general inventive concept provides an inkjet image forming apparatus and an image-shift printing method, which prevent the use of only certain nozzles during iterative printing of identical data.

The present general inventive concept also provides an image forming apparatus and an image-shift printing method, which can print an image on a print medium according to a printing environment.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an image-shift printing method of an inkjet image forming apparatus that includes a printhead having a nozzle unit corresponding to a width of a print medium, the method including iteratively printing identical data on a plurality of print media, and shifting a print image in a width direction of a print medium on the print medium and printing the print image in each iterative printing.

The image-shift printing method may further include inputting a printing environment, and the shifting of the print image in the width direction of the print medium may include shifting the print image according to the printing environment and printed on the print medium.

The shifting of the print image may further include depositing ink droplets ejected from different nozzles in each iterative printing on the same positions on the print image.

The shifting of the print image may further include shifting the print image on the print medium by an integer multiple of a nozzle pitch in the nozzle unit in each iterative printing, and then printing the print image.

The foregoing and/or other aspects of the present general inventive concept may also be achieved by providing an inkjet image forming apparatus including a print medium transferring unit to transfer a print medium in a first direction, a printhead which includes a nozzle unit corresponding to at least a width of the print medium is installed along a second direction, and prints a print image by ejecting ink onto the print medium, and a control unit to generate a first control signal to synchronize operations of the print medium transferring unit and the printhead so that the print image is shifted in a width direction of the print medium and printed on the print medium when identical data corresponding to the print image is iteratively printed on a plurality of the print media.

The inkjet image forming apparatus may further include a printing environment information unit to store printing environment information corresponding to a predetermined printing environment when printing according to the predetermined printing environment, wherein the control unit generates a second control signal to shift and print the print image on the print medium according to the printing environment information stored in the printing environment information unit.

The control unit may generate a third control signal so that ink droplets ejected from different nozzles in each iterative printing are deposited on the same position on the print image.

The control unit may generate a fourth control signal to shift the print image on the print medium by an integer multiple of a nozzle pitch between adjacent nozzles of the nozzle unit in each iterative printing.

The foregoing and/or other aspects of the present general inventive concept may also be achieved by providing an image-shift printing method of an inkjet image forming apparatus that includes a printhead having a nozzle unit corresponding to a width of a print medium, the method including, iteratively printing identical data on a plurality of print media, longitudinally moving the printhead in each iterative printing, and forming and printing a print image in the same position on the print media using the moved printhead.

The image-shift printing method may further include inputting a printing environment, wherein the longitudinally moving the printhead may include moving the printhead corresponding to the printing environment.

The longitudinally moving the printhead may include moving the printhead by an integer multiple of a nozzle pitch between adjacent nozzles of the nozzle unit in each iterative printing.

The forming and printing of the print image may include depositing ink droplets ejected from different nozzles in each iterative printing on the same positions of the print image after the printhead is moved.

The foregoing and/or other aspects of the present general inventive concept may also be achieved by providing an inkjet image forming apparatus including a print medium transferring unit to transfer a print media in a first direction, a printhead which includes a nozzle unit corresponding to a width of the print medium and is installed along a second direction to prints an image by ejecting ink onto the print medium, a carriage including the printhead, a carriage moving unit to move the carriage in the second direction, and a control unit to generate a first control signal to synchronize the operations of the printhead and the carriage moving unit so that the image is formed in the same position on the print media after the printhead is longitudinally moved.

The inkjet image forming apparatus may further include a printing environment information unit to store printing environment information corresponding to a predetermined printing environment when printing according to the predetermined printing environment, wherein the control unit generates a second control signal to move the printhead according to the printing environment information stored in the printing environment information unit.

The control unit may generate a second control signal to move the printhead by an integer multiple of a nozzle pitch between adjacent nozzles of the nozzle unit in each iterative printing.

The control unit may generate a second control signal so that ink droplets ejected from different nozzles are deposited on the same positions of the print image after the printhead is moved.

The carriage moving unit may include a carriage moving motor, carriage moving rollers, one of which is connected to the carriage moving motor and other one of which is connected to a main frame, and a carriage moving belt which is connected to the carriage and supported by the carriage moving rollers, and moves the carriage in the second direction.

The carriage moving unit may include a guide rod connected to the carriage and extending along the second direction, and a driving unit to move the guide rod in the second direction.

The driving unit may include, a driving motor including a gear, a connection gear whose outer circumference has gear teeth to mesh with the gear of the driving motor and whose inner circumference has a female gear, and a lead screw to mesh with the female gear of the connection gear.

The driving unit may include a piezoelectric actuator.

The carriage moving unit may include an adjusting portion in contact with the carriage to move the carriage in the second direction.

The adjusting portion may include an eccentric cam which is rotatably installed on the main frame in contact with the carriage, and a driving source to rotate the eccentric cam.

The inkjet image forming apparatus may further include a bias portion to bias the carriage moved by the adjusting portion toward an original position of the carriage.

The bias portion may include an elastic member installed between the main frame and the carriage.

The foregoing and/or other aspects of the present general inventive concept may also be achieved by providing an image forming apparatus including a print unit disposed on a print medium along which a first print medium and a second print medium pass, and a control unit to control the print unit to be in a first position with respect to the first print medium when a first image is printed, and to be in a second position with respect to the second print medium when a second image is printed on the second print medium.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a specific printing pattern printed by a conventional inkjet image forming apparatus;

FIG. 2 is a cross-sectional view of an inkjet image forming apparatus according to an embodiment of the present general inventive concept;

FIG. 3 is a schematic view of a printhead of the inkjet image forming apparatus of FIG. 2;

FIG. 4 is a schematic view of a printhead of the inkjet image forming apparatus of FIG. 2;

FIG. 5 is a block diagram of the image forming system of FIG. 2;

FIG. 6 is a block diagram illustrating an image forming process of the inkjet image forming apparatus of FIG. 5;

FIG. 7 illustrates printing patterns generated when identical data is iteratively printed on a plurality of print media in the image forming apparatus of FIG. 2;

FIG. 8 is a flow chart illustrating an image-shift printing method according to an embodiment of the present general inventive concept;

FIG. 9 is a cross-sectional view of an inkjet image forming apparatus according to another embodiment of the present general inventive concept;

FIG. 10 is a perspective view illustrating a printhead unit and a carriage moving unit of the inkjet image forming apparatus of FIG. 9;

FIG. 11 is a perspective view illustrating a printhead unit and a carriage moving unit of the inkjet image forming apparatus of FIG. 9;

FIG. 12 is a cross-sectional view of a portion of the printhead unit and carriage moving unit illustrated in FIG. 11;

FIG. 13 is a plan view illustrating a printhead unit and a carriage moving unit of the inkjet image forming apparatus of FIG. 9;

FIG. 14 is a perspective view of an eccentric cam of the carriage moving unit in FIG. 13; and

FIG. 15 illustrates printing patterns generated when identical data is iteratively printed on a plurality of print media in the image forming apparatus of FIG. 9.

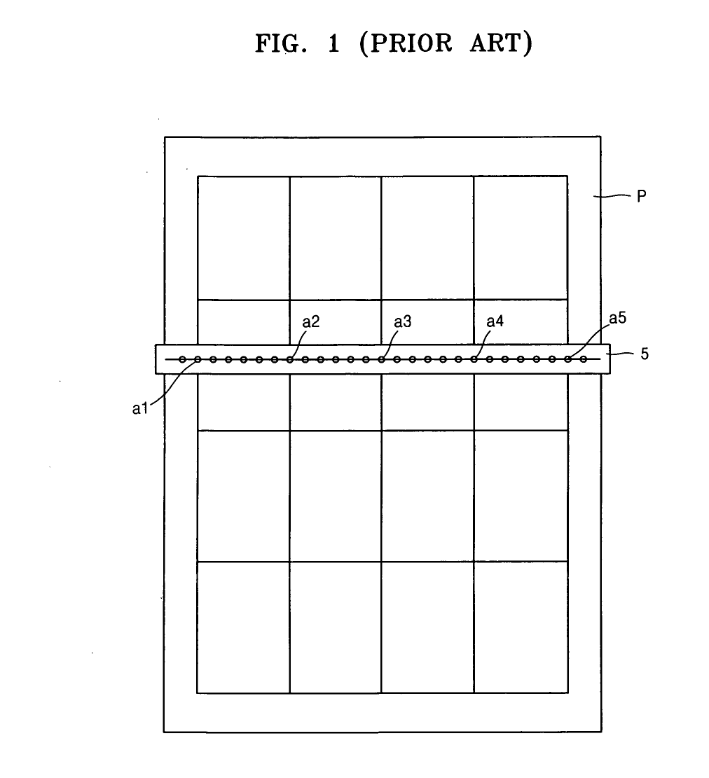

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

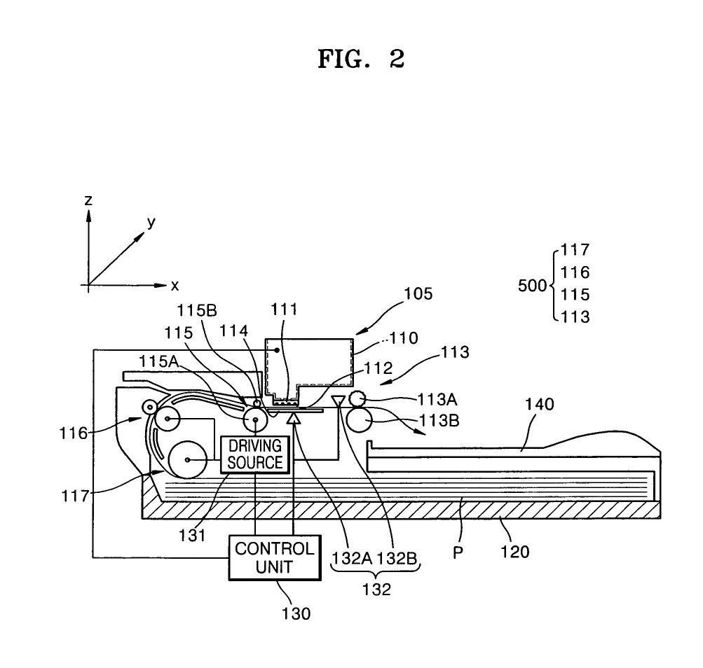

FIG. 2 is a cross-sectional view of an inkjet image forming apparatus according to an embodiment of the present general inventive concept. The inkjet image forming apparatus may have a nozzle unit having a length that corresponds to a width of a print medium.

Referring to FIG. 2, the inkjet image forming apparatus includes a feeding cassette 120, a printhead unit 105, a supporting member 114 disposed opposite to the printhead unit 105 with respect to a print medium path, a detecting unit 132 to detect a malfunctioning nozzle, a print medium transferring unit 500 to transfer a print medium P in a first direction, and a stacking unit 140 on which a discharged print medium P is stacked. In addition, the inkjet image forming apparatus further includes a control unit 130 to control each component thereof.

The print medium P is stacked on the feeding cassette 120. The print medium P is transferred from the feeding cassette 120 to a printhead 111 by the print medium transferring unit 500, which is described below. In the present embodiment, the first direction, i.e., an x direction, indicates a direction or path in which the print medium P is transferred, while a second direction, i.e., a y direction, indicates a direction of a width of the print medium P (i.e., a width direction), that is, a longitudinal direction of the printhead 111. The first direction may or may not be perpendicular to the second direction.

The print medium transferring unit 500 transfers the print medium P along a predetermined path and includes a pick-up roller 117, an auxiliary roller 116, a feeding roller 115, and a discharging roller 113. The print medium transferring unit 500 is driven by a driving source 131, such as a motor, and provides a transferring force to transfer the print medium P. The driving source 131 is controlled by the control unit 130, which is described below.

The pick-up roller 117 is installed at one side of the feeding cassette 120. The pick-up roller is rotated while pressing a top side of the print medium P, thereby feeding the print medium P outside of the feeding cassette 120.

The feeding roller 115 is installed at an inlet side of the printhead 111 and feeds the print medium P drawn out from the feeding cassette 120 by the pick-up roller 117 to the printhead 111. The feeding roller 115 may align the print medium P before the print medium P passes under the printhead 111 such that ink can be ejected to a desired portion of the print medium P. The feeding roller 115 includes a driving roller 115A to supply a transferring force to transfer the print medium P, and an idle roller 11 5B to be elastically engaged with the driving roller 115A. The auxiliary roller 116 may be further installed between the pick-up roller 117 and the feeding roller 115 to transfer the print medium P along the predetermined path.

The discharging roller 113 is installed at an outlet side of the printhead 111 and discharges the print medium P on which a printing operation has been completed, to an outside of the inkjet image forming apparatus. The discharged print medium P is stacked on the stacking unit 140. The discharging roller 113 includes a star wheel 113A installed in the width direction of the print medium P, and a supporting roller 113B which is disposed opposite to the star wheel 113A and supports a rear side of the print medium P. The print medium P may wrinkle due to ink ejected onto a top side of the print medium P while passing under a nozzle unit 112 (i.e., under the printhead 111 ). If wrinkling is severe, the print medium P contacts a bottom surface of the nozzle unit 112 or a body 110, and wet ink is spread (or smeared) on the print medium P. and an image printed thereon may be contaminated. A distance between the print medium P and the nozzle unit 112 may not be maintained due to the wrinkling of the print medium P. The star wheel 113A prevents the print medium P fed in a downward direction of the nozzle unit 112 from contacting the bottom surface of the nozzle unit 112 or the body 110, or prevents the distance between the print medium P and the bottom surface of the nozzle unit 112 or the body 110 from being changed. The star wheel 113A is installed such that at least a portion of the star wheel 113A protrudes further downward from the nozzle unit 112 and makes a point contact with the top side of the print medium P. According to the above structure, the star wheel 113A makes the point contact with the top side of the print medium P so that an ink image that has been ejected from the nozzle unit 112 and is not yet dried is prevented from being contaminated. In addition, a plurality of star wheels may be installed so as to smoothly transfer the print medium P. When the plurality of star wheels are installed in parallel with the transferring direction of the print medium P, a plurality of supporting rollers corresponding to the plurality of star wheels may be further installed.

When printing is continuously performed, the print medium P is discharged and stacked on the stacking unit 140 and subsequently a next print medium P is discharged before ink ejected on the top side of the previous print medium P is dried, so that a rear side of the next print medium P may be contaminated by ink. To prevent this problem, an individual drying unit (not illustrated) may be further installed.

The supporting member 114 is installed below the printhead 111 and supports the rear side of the print medium P to maintain a predetermined distance between the nozzle unit 112 and the print medium P. The predetermined distance between the nozzle unit 112 and the print medium P may be about 0.5-2.5 mm.

The malfunctioning nozzle may be a bad or non-droplet ejecting nozzle. That is, the malfunctioning nozzle does not eject ink due to several causes or ejects a smaller amount of ink droplets. The malfunctioning nozzle may be generated in a process of manufacturing the printhead 111 or during printing. Information on the malfunctioning nozzle generated in the manufacturing process is stored in a memory (not illustrated) installed in the printhead 111. Otherwise, the malfunctioning nozzle generated during printing is detected by the detecting unit 132. That is, the detecting unit 132 detects the malfunctioning nozzle of the nozzle unit 112 formed on the printhead 111.

The detecting unit 132 may include a first detecting unit 132A to detect malfunctioning nozzles in the nozzle unit 112 before printing and a second detecting unit 132B to detect malfunctioning nozzles in the nozzle unit 112 during printing. The first detecting unit 132A detects whether or not nozzles are clogged by radiating light directly onto the nozzle unit 112, and the second detecting unit 132B detects whether or not the malfunctioning nozzle exists in the nozzle unit 112 by radiating light onto the print medium P when the print medium P is transferred. An embodiment of the second detecting unit 132B may be an optical sensor including a light-emitting sensor (e.g., a light emitting diode) that radiates light onto the print medium P and a light-receiving sensor that receives light reflected from the print medium P. An output signal from the light-receiving sensor is input to the second detecting unit 132B. The second detecting unit 132B detects whether or not the malfunctioning nozzle exists in the nozzle unit 112 in response to the output signal, and information about whether or not the malfunctioning nozzle exists in the nozzle unit 112 is transmitted to the control unit 130, which is described below. The detecting unit 132 detects whether or not the malfunctioning nozzle exists in the nozzle unit 112 using the above-described series of processes. The light emitting sensor and the light receiving sensor can be formed as an one-body type or as several separate units. The structures and functions of the optical sensor may be well known, and thus a detailed description thereof will be omitted.

The printhead unit 105 prints an image by ejecting ink onto the print medium P. and includes the body 110, the printhead 111 installed at one side of the body 110, and the nozzle unit 112 formed on the printhead 111. The feeding roller 115 is rotatably installed at an inlet side of the nozzle unit 112, and the discharging roller 113 is rotatably installed at an outlet side of the nozzle unit 112. Each of the nozzles in the nozzle unit 112 includes a driving circuit (not illustrated) and a cable (not illustrated) to receive printing data, electric power, control signals, etc. The cable may be a flexible printed circuit (FPC) or a flexible flat cable (FFC).

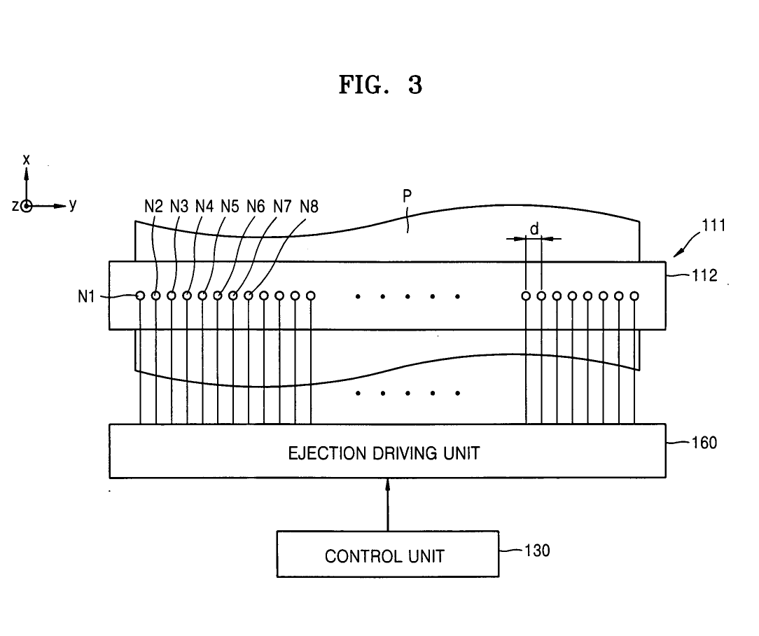

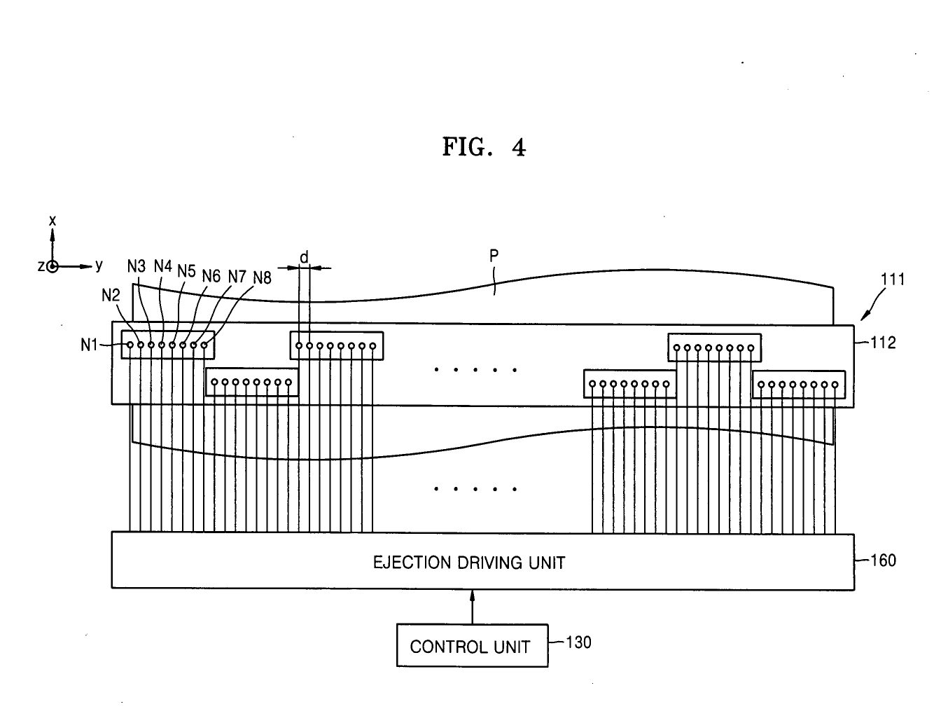

FIG. 3 is a schematic view of a printhead usable with the inkjet image forming apparatus of FIG. 2 according to an embodiment of the present general inventive concept. FIG. 4 is a schematic view of another printhead usable with the inkjet image forming apparatus of FIG. 2 according to another embodiment of the present general inventive concept. For convenience of explanation, like reference numerals refer to like elements having the same structures and functions. Reference symbols N1 through N8 indicate nozzles in the printhead 111, and ‘d’ indicates a nozzle pitch (i.e., a distance) between two adjacent nozzles.

Referring to FIGS. 2, 3 and 4, the printhead 111 includes the nozzle unit 112 ejecting ink onto the print medium P and is installed along the second direction (i.e., the y direction). The printhead 111 uses heat energy or a piezoelectric device as an ink ejecting source, and is manufactured to have a high resolution through a semiconductor manufacturing process such as etching, deposition or sputtering. The nozzle unit 112 may correspond to the width of the print medium P or may be formed longer than the width of the print medium P. Although the printhead 111 illustrated in FIGS. 3 and 4 ejects only ink of one color, the printhead 111 according to the present general inventive concept can be a color printhead ejecting ink of different colors. Although not illustrated, the printhead 111 may include a plurality of nozzle arrays which are separated from each other along the transferring direction of the print medium P and eject ink of the same color. Nozzles of the nozzle unit 112 may be disposed in a zigzag pattern to improve resolution.

Although not illustrated, a removable cartridge typed ink container is provided in the body 110. Further, the body 110 may include chambers, each chamber having an ejection driving unit 160 (see FIGS. 3 and 4), for example, piezoelectric elements or heat-driving typed heaters, that are connected to respective nozzles of the nozzle unit 112 to provide pressure to eject ink, a passage, for example, an orifice, to supply ink contained in the body 110 to each chamber, a manifold that is a common passage to supply the ink that flows through the passage to the chamber, and a restrictor that is an individual passage to supply the ink from the manifold to each chamber. The chamber, the ejecting unit, the passage, the manifold, and the restrictor are well-known , and thus detailed descriptions thereof will be omitted. In addition, the printhead 111 connected to the body 110 may be mounted as a cartridge type in a carriage 106.

The ejection driving unit 160 includes an actuator, which provides an ejecting force to ink droplets, and separately drives a plurality of nozzles N1 through N8. In general, a printhead of an inkjet image forming apparatus may be classified into two types according to an actuator that provides an ejecting force to ink droplets. The first type is a thermal driving printhead that generates bubbles in ink using a heater, thereby ejecting ink droplets due to an expanding force of the bubbles. The second type is a piezoelectric driving printhead that ejects ink droplets using a pressure applied to ink due to deformation of a piezoelectric device. The ejection driving unit 160 separately drives each of nozzles N1 through N8 to print an image. Ink ejecting operations of the nozzles N1 through N8 in the nozzle unit 112 driven by the ejection driving unit 160 are controlled by the control unit 130, which is described below.

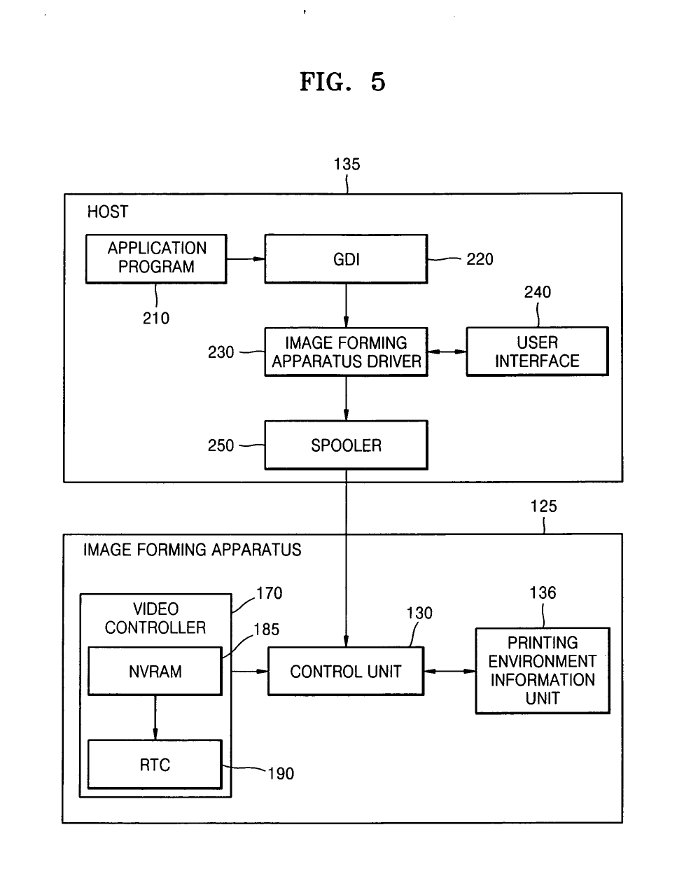

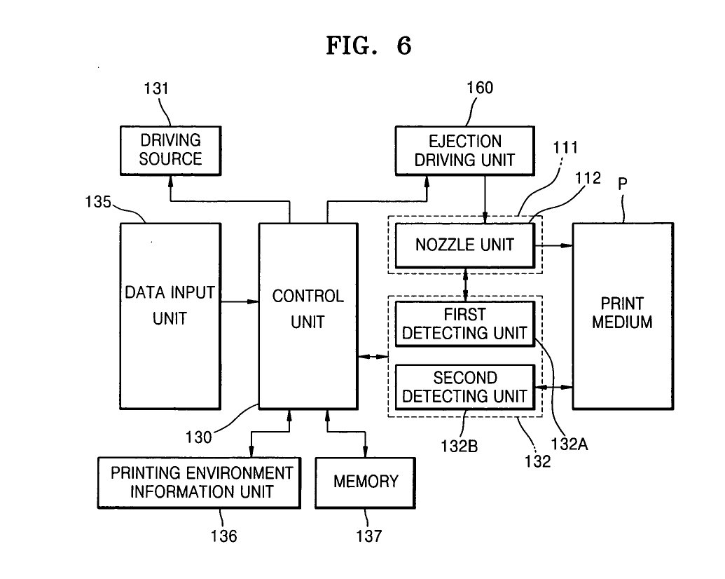

FIG. 5 is a block diagram of the image forming system of FIG. 2. FIG. 6 is a block diagram illustrating the image forming process of the inkjet image forming apparatus of FIG. 5. The image forming system includes a data input unit 135 and an inkjet image forming apparatus 125.

Referring to FIGS. 2 and 5, the data input unit 135 is a host system, such as a personal computer (PC), a digital camera, or a personal digital assistant (PDA), and receives image data in the order of pages to be printed. The data input unit 135 includes an application program 210, a graphics device interface (GDI) 220, an image forming apparatus driver 230, a user interface 240, and a spooler 250. The application program generates and edits an object that can be printed by the inkjet image forming apparatus 125. The GDI 220, which is a program installed in the data input unit 135, receives the object from the application program, sends the received object to the image forming apparatus driver 230, and generates commands related to the object in response to a request from the image forming apparatus driver 230.

The image forming apparatus driver 230 is a program installed in the data input unit 135 to generate commands that can be interpreted by the inkjet image forming apparatus 125. The user interface 240 for the image forming apparatus driver 230 is a program installed in the data input unit 135 to provide environment variables that are used by the image forming apparatus driver 230 to generate the commands. The spooler 250 is a program installed in the data input unit 135 that can be included in an operating system of the host system and transmits the commands generated by the image forming apparatus driver 230 to an input/output device (not illustrated) that is connected to the image forming apparatus 125.

The inkjet image forming apparatus 125 includes a video controller 170, the control unit 130, and a printing environment information unit 136. The video controller 170 includes a non-volatile random access memory (NVRAM) 185, a static random access memory (SRAM, not illustrated), a synchronous dynamic random access memory (SDRAM, not illustrated), a NOR Flash (not illustrated), and a real time clock (RTC) 190.

The video controller 170 interprets the commands generated by the image forming apparatus driver 230 to convert the commands into corresponding bitmaps and transmits the bitmaps to the control unit 130. The control unit 130 transmits the bitmaps to each component of the inkjet image forming apparatus 125 to print the image on the print medium P. Thus, the inkjet image forming apparatus 125 prints the image on the print medium P.

Referring to FIGS. 2, 5, and 6, the control unit 130 may be mounted on a motherboard (not illustrated) of the inkjet image forming apparatus 125, and controls an ejecting operation of the nozzle unit 112 installed in the printhead 111, transferring operations of the print medium transferring unit 500. That is, the control unit 130 synchronizes operations of each component so that the ink ejected from the nozzle unit 112 can be deposited on a desired area of the print medium P when the printing operation is performed according to a predetermined printing environment. The control unit 130 stores the image data input through the data input unit 135 in a memory 137, and confirms whether the image data desired to be printed is completely stored in the memory 137.

The printing environment information unit 136 stores a plurality of printing environment information corresponding to each printing environment when image data input from the application program 210 is printed according to the predetermined printing environment. That is, the printing environment information unit 136 stores printing environment information corresponding to each printing environment input from the user interface 240. Here, the printing environment information includes at least one of a printing density, a resolution, a size of a print medium, a type of a print medium, a temperature, a humidity, and whether printing operations should be performed in a continuous printing manner. The control unit 130 controls the operations of the nozzle unit 112 in the printhead 111 and the print medium transferring unit 500 according to each printing environment information stored in the printing environment information unit 136 corresponding to the input printing environment. For example, the control unit 130 generates control signals for iterative printing of identical data or for the operation of each component corresponding to a printing mode, such as a normal mode, a draft mode, and a high-quality mode input from the user interface 240.

When the storing of the image data is completed, the control unit 130 generates a control signal corresponding to the input printing environment to operate a driving source 131, and the print medium P is transferred by the print medium transferring unit 500 which is driven by the driving source 131. The control unit 130 controls the nozzle unit 112 to eject ink onto the print medium P when the print medium P approaches the nozzle unit 112. That is, the control unit 130 generates and outputs a signal to control the operation of the nozzle unit 112. The nozzle unit 112 receives the control signal and prints the image data on the print medium P. Here, the control unit 130 controls the ejection driving unit 160 according to the printing environment information stored in the printing environment information unit 136 to separately drive the nozzle unit 112. Hereinafter, when the identical data is iteratively printed on a plurality of print media, the operation of the control unit 130 is described in detail below with reference the attached drawings.

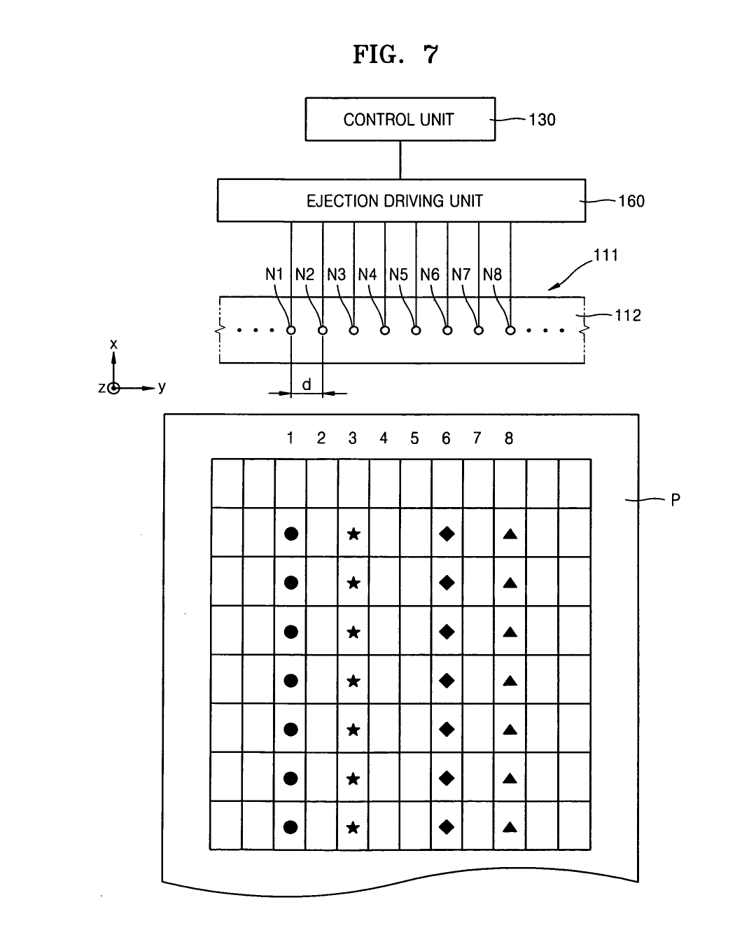

FIG. 7 illustrates printing patterns generated when identical data is iteratively printed on a plurality of print media in the image forming apparatus of FIG. 2. Here, ★, ●, ♦, and ▴ indicate first, second, third and fourth printing ink dots formed on first, second, third, and fourth print media, respectively. For simplicity of the description, the first through fourth images printed on separated print media will be described as if the images are printed on the same print medium. Also, reference symbols N1 through N8 indicate nozzles in the printhead 111, and reference numerals 1 through 8 indicate positions where ink dots ejected from the nozzles are deposited on the print medium P. The present general inventive concept describes an example where lines parallel to the transporting direction of the print medium P are iteratively printed on a plurality of print media.

Referring to FIG. 7, the nozzle N3 is used in the first printing, the nozzle N1 is used in the second printing, the nozzle N6 is used in the third printing, and the nozzle N8 is used in the fourth printing. Here, a second printing pattern is printed on a position shifted leftward by two nozzle pitches from a first printing pattern, a third printing pattern is printed on a position shifted rightward by three nozzle pitches from the first printing pattern, and the fourth printing pattern is printed on a position rightward shifted by five nozzle pitches from the first printing pattern. That is, when identical data is iteratively printed on a plurality of print media, the control unit 130 generates control signals controlling the operation of the ejection driving unit 160 so that the print image is shifted along the width of the print medium P in each iterative printing. Accordingly, the control unit 130 generates control signals to perform nozzle-shifting so that ink droplets ejected from different nozzles are deposited on the same position of the print image in each iterative printing. For example, when a certain image is iteratively printed, the control unit 130 generates control signals that change the nozzles ejecting ink droplets in each iterative printing such that the nozzle N3 ejects ink droplets ★ in the first printing, the nozzle N1 ejects ink droplets ● in the second printing, the nozzle N6 ejects ink droplets ♦ in the third printing, and the nozzle N8 ejects ink droplets ▴ in the fourth printing. Here, the print image is shifted by an integer multiple of the nozzle pitch ‘d’ in each iterative printing.

In addition, when printing according to a predetermined printing environment, the control unit 130 may generate a control signal that shifts and prints a print image on the print medium P according to the printing environment information stored in the printing environment information unit 136. Meanwhile, when identical data is iteratively printed on a plurality of print media, a printing operation with nozzle-shifting may cause ink droplets to be ejected outside of a print medium P, which significantly degrades the printing quality and the lifetime of the inkjet image forming apparatus 125. Alternatively, the control unit 130 may generates control signals so that a print image is shifted and printed on the print medium P by the nozzle-shifting corresponding to the printing environment information stored in the printing environment information unit 136 or printing environment information input through the user interface 240 (see FIG. 5). A degree (range or distance) of the nozzle-shifting may be stored in the printing environment information unit 136 (see FIG. 5) or directly input via the user interface 240 (see FIG. 5). In general, the nozzle pitch ‘d,’ a distance between nozzles in the printhead 111 having a resolution of 1200 dots per inch (dpi), is 1/1200 inch. When identical data is iteratively printed, even if the print image is shifted within ten nozzle pitches, the range (distance) of nozzle-shifting is merely 1/120 inch (0.21 mm). Since all document generally have a margin, i.e., a distance from the edge of the print medium P to the print image, of 5 to 15 mm, ink cannot be ejected outside of the print medium P although the printing medium P is printed with nozzle-shifting. If the degree of nozzle-shifting is greater than a predetermined size, the shifty of the print image becomes visible. When iteratively printing identical data on certain sheets of print media, if the present shifting degree of the print image is greater than a predetermined maximum value, the print image should be shifted back to the initial position for the next printing. Here, counts of iterative printings of identical data before shifting a print image back to its initial position is determined according to the input printing environment by the control unit 130 (see FIG. 5). Therefore, the printing with nozzle-shifting can increase the lifetime of the nozzles.

When printing in a high-resolution mode, for example, when printing photographs, the print medium P is printed without a margin. In this case, the nozzles may not be shifted even when identical data is iteratively printed on a plurality of print media. That is, as described above, printing may be performed by nozzle-shifting corresponding to each of printing environment conditions.

As described above, the control unit 130 generates control signals to print with shifting a print image corresponding to various input printing environments.

Hereinafter, an image-shift printing method of an inkjet image forming apparatus according to various embodiments of the present general inventive concept is described in detail with reference to the attached drawings.

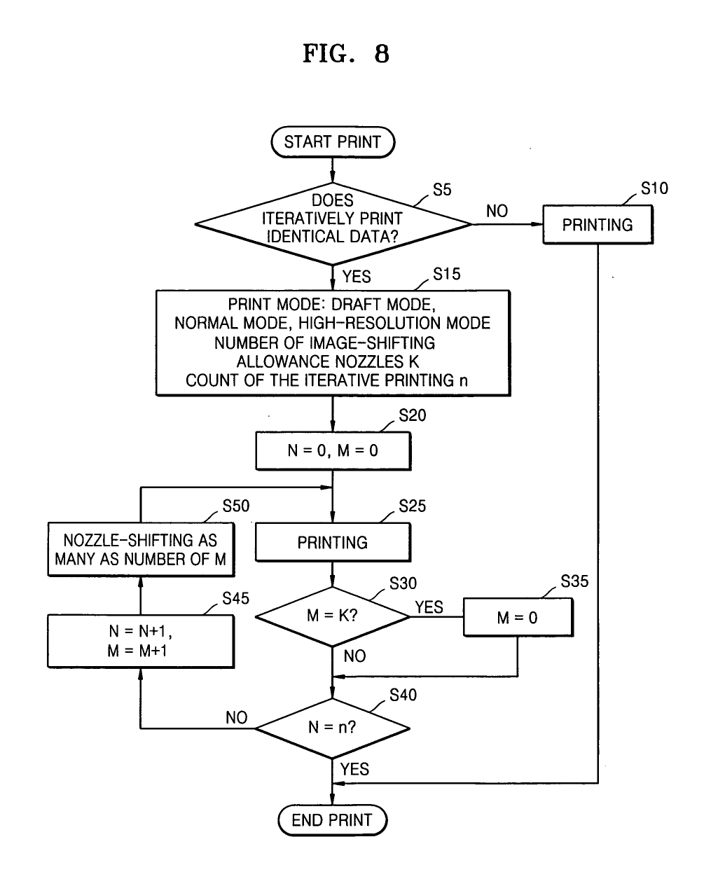

FIG. 8 is a flow chart illustrating an image-shift printing method according to an embodiment of the present general inventive concept. The image-shift printing method of FIG. 8 can be performed by the inkjet image printing apparatus of FIG. 2 having a structure as illustrated in FIG. 5. Referring to FIGS. 2, 5 and 8, the image-shift printing method according to an embodiment of the present general inventive concept performs an image forming process depending on whether or not identical data is not iteratively printed in operation S5.

If the identical data is not iteratively printed, the print medium P is printed by ejecting ink in operation S10.

If the identical data is iteratively printed, the print image is shifted in the width direction of the print medium P and printed on the print medium R In other words, in the image-shift printing method according to the embodiment of the present general inventive concept illustrated in FIG. 7, the nozzle-shifting is performed so that ink droplets ejected from different nozzles are disposed on the same position of the print image in each iterative printing. Here, the print image is shifted by an integer multiple of the nozzle pitch ‘d’ on the print medium P in each iterative printing.

In addition, the image-shift printing method according to the embodiment of the present general inventive concept further includes inputting the printing environment in operation S15, and the printing is performed when the print image is shifted corresponding to the input printing environment. The input printing environment may include the number of image-shifting allowance nozzles ‘K,’ a count of the iterative printing ‘n,’ or the print mode (draft, normal, and high-resolution).

As an example, ‘n’ iterative printing of the identical data is described below. The iterative printing may cause ink droplets to be ejected outside of the print medium P. To prevent this, the value ‘K,’ i.e., the nozzle-shifting degree, may be determined corresponding to each of printing environments input from the user interface 240. That is, the image-shift printing method according to an embodiment of the present general inventive concept shifts the print image for printing within the number of image-shifting allowance nozzles ‘K’ corresponding to the printing environment information stored in the printing environment information unit 136.

In the method illustrated in FIG. 8, ‘N’ represents a count of printings already performed and ‘M’ represents a count of the iterative printing until the print image is shifted back to its initial position. When the first printing is performed, ‘N’ and ‘M’ are set to zero in operation S20. A printing operation is performed in operation S25. The count ‘M’ is compared with the value ‘K’ in operation S30, and the count ‘N’ is compares with the count of the iterative printing ‘n’ in operation S40. If ‘M’ is smaller than ‘K’ and ‘N’ is smaller than ‘n,’ the values of ‘N’ and ‘M’ are increased by 1 in operation S45. The nozzles are shifted so as to shift the print image on the print medium P in operation S50. The printed image is shifted by repeating of the above operations. If ‘M’ becomes equal to ‘K’, ‘M’ isset again to zero (operation S35) and the next print image is printed at the same position as the first printing. That is, the image-shift printing method according to an embodiment of the present general inventive concept iteratively prints identical data on several sheets of paper, shifts the print image to its initial position, and then prints the print image. In other words, if the count of the iterative printing ‘M’ becomes greater than the predetermined maximum shifting distance, i.e., ‘K,’ the print image is shifted back to its initial position, and then printed.

The count of the iterative printing until the print image is shifted to its initial position is determined by the printing environment input from the printing environment information unit 136 or the user interface 240. When ‘N’ becomes equal to ‘n’ in operation S40, the printing is finished. Although the case of the printing with nozzle-shifting ‘M’ times in operation S50, each iterative printing is described above as an example in the present embodiment, the present general inventive concept should not be limited to the embodiment set forth herein. A nozzle-shifting method according to the present general inventive concept can have various embodiments, for example, a symmetric nozzle-shifting like “−1, +1, −2, +2, −3, +3 . . . ” according to initial positions of nozzles.

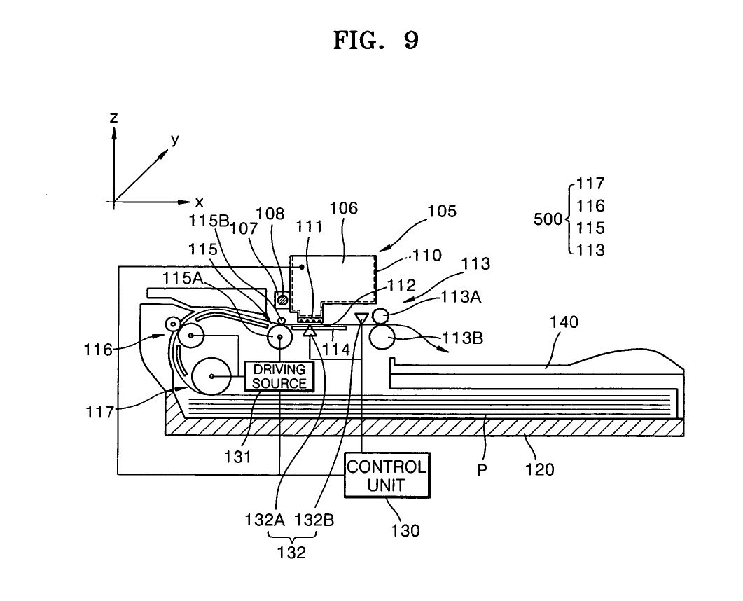

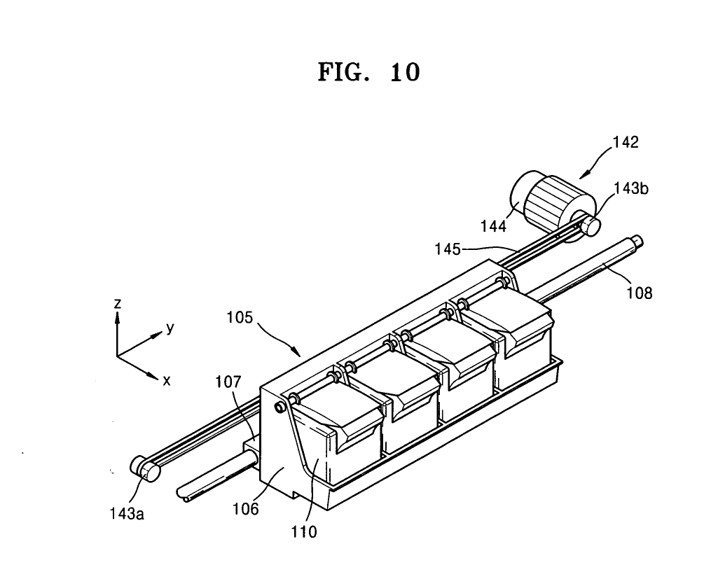

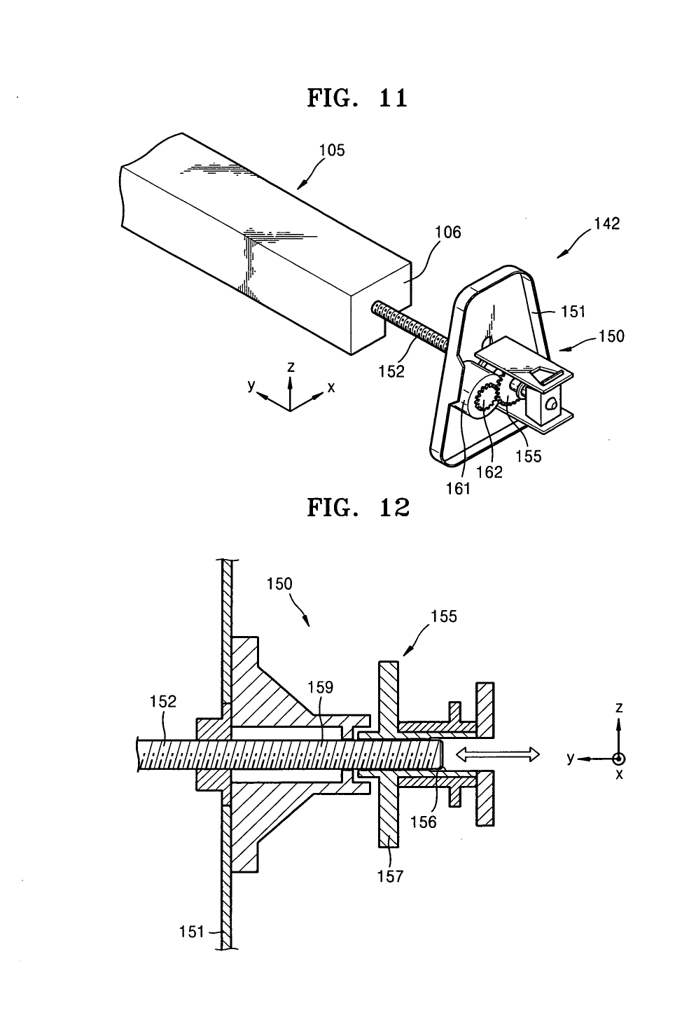

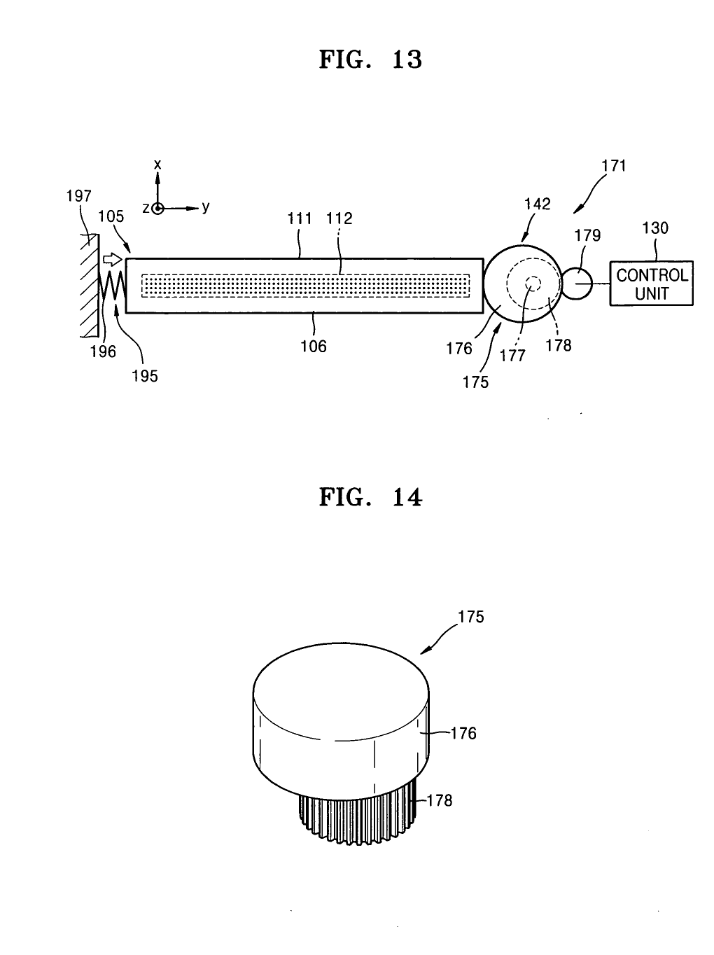

FIG. 9 is a cross-sectional view of an inkjet image forming apparatus according to another embodiment of the present general inventive concept. FIG. 10 is a perspective view illustrating a printhead unit 105 and a carriage moving unit 142 of the inkjet image forming apparatus of FIG. 9 according to an embodiment of the present general inventive concept. FIG. 11 is a perspective view illustrating the printhead unit 105 and the carriage moving unit 142 of the inkjet image forming apparatus of FIG. 9 according to another embodiment of the present general inventive concept. FIG. 12 is a cross-sectional view of a portion of the units in FIG. 11. FIG. 13 is a plan view illustrating the printhead unit 105 and the carriage moving unit 142 of the inkjet image forming apparatus of FIGL 9 according to still another embodiment of the present general inventive concept. FIG. 14 is a perspective view of an eccentric cam in FIG. 13. Since the inkjet image forming apparatus has an overall structure and functions similar to those of the inkjet image forming apparatus illustrated in FIGS. 2 through 8, a detailed description thereof will be omitted. In addition, like reference numerals refer to like elements having the same structures and functions.

Referring to FIGS. 9 and 10, the inkjet image forming apparatus includes a feeding cassette 120, the printhead unit 105, a supporting member 114 opposite to the printhead unit 105, the carriage moving unit 142 to move the printhead unit 105 in a second direction, (i.e., a y direction), a print medium transferring unit 500 to transfer a print medium P, in a first direction (i.e. an x direction) and a stacking unit 140 on which a discharged print medium P is stacked. In addition, the inkjet image forming apparatus includes a control unit 130 to control each component of the inkjet image forming apparatus.

The printhead unit 105 includes a body 110, a printhead 111 installed on a bottom surface of the body 110, a nozzle unit 112 formed on the printhead 111, and a carriage 106 where the body 110 is mounted. The body 110 is mounted into the carriage 106 in a cartridge type manner and the carriage 106 is movably installed along the second direction (i.e., the y direction), which is a longitudinal direction of the printhead 111. The carriage 106 is moved by the carriage moving unit 142, which is described below. Accordingly, the printhead 111 prints an image by ejecting ink onto the print medium P while moving in the second direction (i.e., the y direction) or when it stops moving.

Referring to FIG. 10, the body 110 is mounted in the carriage 106. The printhead 111 connected to the body 110 is mounted as a cartridge type in the carriage 106. The carriage moving unit 142 moving the carriage 106 in the second direction, i.e., the y direction, includes a carriage moving motor 144, carriage moving rollers 143a and 143b, and a carriage moving belt 145. The carriage moving motor 144 receives electric power from a main frame (not illustrated) of the inkjet image forming apparatus. The carriage moving roller 143b is connected to the carriage moving motor 144, and the carriage moving roller 143a is installed in the main frame (not illustrated). The carriage moving belt 145 is supported by the carriage moving rollers 143a and 143b, and is disposed around the carriage moving rollersl43a and 143b. The carriage moving belt 145 is connected to the carriage 106. The carriage 106 is moved to a predetermined position by the carriage moving motor 144 according to a control signal generated by the control unit 130. The motion of the carriage 106 is guided by a guide shaft 108. A combining unit 107 is disposed at one side of the carriage 106. The guide shaft 108 is inserted into the combining unit 107 formed in a hollow shape and guides the motion of the carriage 106.

Referring to FIGS. 11 and 12, the carriage moving unit 142 is connected to the carriage 106 and includes a guide rod 152 extending along the second direction (i.e., the y direction) and a driving unit 150 to move the guide rod 152 in the second direction (i.e., the y direction). A lead screw 159 meshing with a female gear of a connection gear 155 (which is described below) is formed on an outer circumference of the guide rod 152. A support 157 supports the lead screw 159 and the driving unit 150. The driving unit 150 includes a frame 151 fixed in the inkjet image forming apparatus, the connection gear 155 whose inner circumference has the female gear meshing with the gear of the lead screw 159 whose outer circumference has gear teeth, and a driving motor 161 fixed at the frame 151. The driving motor 161 includes a gear 162 to mesh with the connection gear 155 and to transmit a driving force to the connection gear 155. When the gear 162 driven by the driving motor 161 rotates forwardly or reversely, the connection gear 155 meshing with the gear 162 rotates to transmit the driving force to the lead screw 159 meshing with an inner circumference 156 of the connection gear 155, and thus the guide rod 152 is moved in the second direction (i.e., the y direction). The carriage 106 connected to the guide rod 152 is also moved in the second direction (i.e., the y direction). A piezoelectric device used to drive an accurate positioning device such as an optical mirror can be used as the driving unit 150. The piezoelectric device driven by an electric voltage has a position accuracy of several μm and a high frequency response characteristic. Accordingly, when the driving unit 150 is the piezoelectric device, the position of the carriage 106 can be accurately controlled.

Referring to FIGS. 13 and 14, the carriage moving unit 142 moves the carriage 106 in the second direction (i.e., the y direction). The carriage moving unit 142 includes an adjusting unit 171 and a bias portion 195. The adjusting unit 171 contacts and moves the carriage 106 in the second direction (i.e., the y direction) in a stepwise manner. The adjusting unit 171 includes an eccentric cam 175 that is rotatably installed on a main frame 197 and contacts the carriage 106, and a driving source 179 that rotates the eccentric cam 175. The eccentric cam 175 includes a rotating portion 178 rotatably inserted and installed into the main frame 197, and a contact portion 176 that contacts the carriage 106. The rotating portion 178 is inserted into a combining hole (not illustrated) formed in the main frame 197 and is rotatably installed around one point 177. The rotating portion 178 may be a gear member to which a rotation force is transmitted from the driving source 179, which is described below. In addition, since the contact portion 176 of the rotating portion 178 contacts the carriage 106 and moves the carriage 106 in the second direction (i.e., the y direction) when rotating, the contact portion 176 may be formed to be eccentric with respect to the rotating portion 178. Alternatively, the contact portion 176 may be formed in an elliptical shape. The driving source 179 provides a driving force needed to rotate the eccentric cam 175. A piezoelectric device mainly used in an apparatus requiring precise position control can be used as the driving source 179. The piezoelectric device is well-known in the art, and thus, a detailed description thereof will be omitted. The bias portion 195 biases the carriage 106 moved by the adjusting portion 171 toward its original position. That is, the bias portion 195 elastically biases the carriage 106 in a direction along the printhead 111 towards a point where the carriage 106 contacts the adjusting portion 171. The bias portion 195 may include an elastic member 196 that is installed between the main frame 197 and the carriage 106, to elastically bias the carriage 106 toward its original position. As presented above, the carriage 106 is moved by the adjusting portion 171 and the bias portion 195.

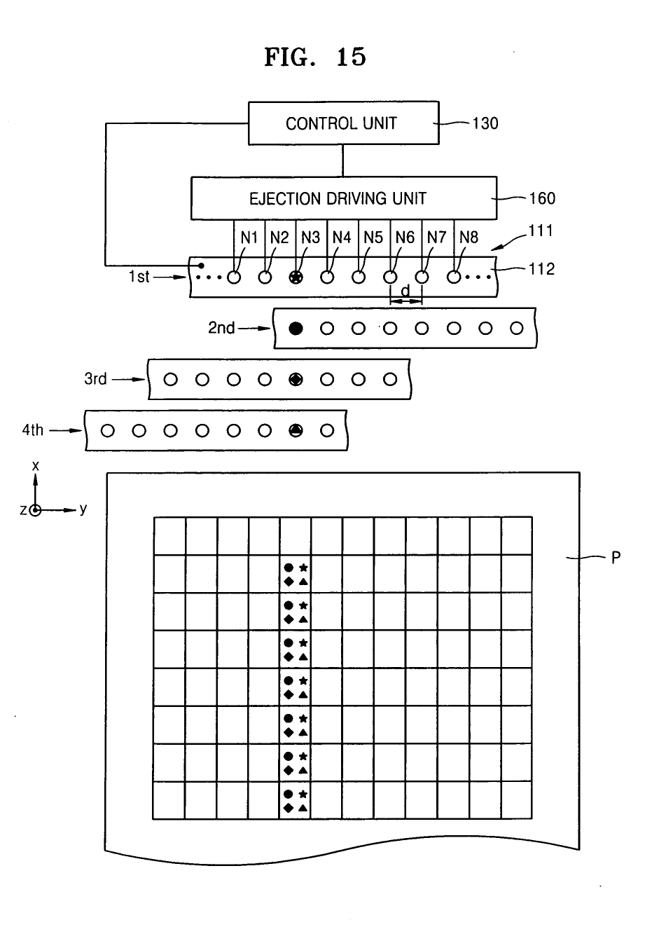

FIG. 15 illustrates printing patterns generated when identical data is iteratively printed on a plurality of print media in the image forming apparatus of FIG. 9. Here, ★, ●, ♦, and ▴ indicate first, second, third and fourth printing ink dots, respectively. For simplicity of the description, the first through fourth images printed on separated print media will be described as if the images are printed on the same print medium. Also, reference symbols N1 through N8 indicate nozzles in the printhead 111, and 1st, 2nd, 3rd, and 4th indicate the positions of printhead 111 at iterative printings. The present general inventive concept describes an example where lines parallel to the transporting direction of the print medium P may be iteratively printed on a plurality of print media using different nozzles of the printhead 111 moving in the y direction. The printing patterns in FIG. 15 may be printed by the inkjet image forming apparatus illustrated in FIG. 9.

Referring to FIGS. 9 and 15, when identical data are iteratively printed on a plurality of print media, the control unit 130 generates control signals to synchronize the operations of the print medium transferring unit 500, the printhead 111, and the carriage moving unit 142 so that the ink ejected from the nozzle unit 112 is deposited on a desired area of the print medium P (that is one of the plurality of print media) after moving the printhead 111 in the second direction (i.e., the y direction).

As illustrated in FIG. 15, a nozzle N3 is used in a first printing, a nozzle N1 is used in a second printing, a nozzle N5 is used in a third printing, and a nozzle N7 is used in a fourth printing. Accordingly, when identical data is iteratively printed on the plurality of print media, the printhead 111 is moved during each iterative printing. That is, when the identical data is iteratively printed on a plurality of print media, the control unit 130 generates control signals to control the printhead 111 and the ejection driving unit 160 to form the image in the same position on the print medium P in each iterative printing. Accordingly, the control unit 130 generates control signals to control the printhead 111 and the ejection driving unit 160 to form the image in the same position on the print medium P in each iterative printing. The control unit 130 generates control signals to move the printhead 111 so that ink droplets ejected from different nozzles are deposited on the same position of the printing medium P in each iterative printing after moving the printhead 111. For example, when a certain image is iteratively printed, the control unit 130 generates control signals that control the operation of the printhead 111 and the ejection driving unit 160 such that ink droplets ★ ejected from the nozzle N3 in the first printing, ink droplets ● ejected from the nozzle N1 in the second printing, ink droplets ♦ ejected from the nozzle N6 in the third printing, and ink droplets ▴ ejected from the nozzle N7 in the fourth printing are deposited on the same positions of the print medium P Here, the control unit 130 moves the printhead 111 along the print medium P by an integer multiple of the nozzle pitch ‘d.’

When printing in a predetermined printing environment, the control unit 130 may generate a control signal to move the printhead 111 corresponding to the input printing environment information stored in the printing environment information unit 136. Since the reason why the printhead 111 is moved corresponding to the printing environment information is the basically same as the reason why a print image is shifted (which is described above with reference to FIGS. 2 through 8) a description thereof will not be provided.

Hereinafter, an image-shift printing method using an inkjet image forming apparatus according to another embodiment of the present general inventive concept will be described. In the present embodiment, the printhead 111 is moved in a longitudinal direction. The present embodiment is similar to the previous embodiment described with reference to FIGS. 2 through 8, therefore a description thereof will not be repeated.

An image-shift printing method according to the embodiment of the present general inventive concept includes iteratively printing identical data on a plurality of print media, moving the printhead in the longitudinal direction (the y direction) in each iterative printing, and printing an image on the same position of a print medium by moving the printhead. Meanwhile, in the moving of the printhead in the longitudinal direction (the y direction) in each iterative printing, the printhead can be moved by an integer multiple of the nozzle pitch ‘d’. Alternatively, in the moving of the printhead in the longitudinal direction (the y direction) in each iterative printing, the printhead can be moved corresponding to an input printing environment. In addition, in the printing of the image on the same position of the print medium by moving the printhead, ink droplets ejected from different nozzles may be deposited on the same positions of the print image after the printhead is moved.

According to the structures and methods described above, unlike conventional structures and methods, when identical data is iteratively printed, an image can be printed by ink droplets ejected from different nozzles in each iterative printing by nozzle-shifting or printhead movement in a second direction in each iterative printing.

As described above, an inkjet image forming apparatus and an image-shift printing method thereof according to various embodiments of the present general inventive concept, unlike conventional apparatuses and methods, can prevent the overuse of a specific nozzle when identical data is iteratively printed, resulting in an increase of the lifetime of a printhead. In addition, the inkjet image forming apparatus and the image-shift printing method for the same according to the present general inventive concept can print an image according to various printing environments. In particular, various embodiments of the inkjet image forming apparatus and method of the present general inventive concept are useful for private or public offices where identical data must be iteratively printed. In addition, the inkjet image forming apparatus and the image-shift printing method for the same according to the present general inventive concept can optimize an image printing by changing moving distances of nozzles or a printhead thereof according to various printing environments.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image-shift printing method of an inkjet image forming apparatus that includes a printhead having a nozzle unit corresponding to at least a width of a print medium and iteratively prints identical data on a plurality of print media, the method comprising:
shifting a print image at least once in a width direction of a print medium on the print medium.

2. The method of claim 1 further comprising:
inputting a printing environment,
wherein the print image is shifted according to the printing environment and printed on the print medium.

3. The method of claim 1, wherein ink droplets ejected from different nozzles of the nozzle unit in each shifting operation are deposited within a shifting allowable range on the print medium.

4. The method of claim 3, wherein the shifting allowable range is bounded by a margin of the print medium so that the print image is not printed on the margin of the print medium.

5. The method of claim 1, wherein the print image is shifted in the width direction of the print medium on the print medium and printed on the print medium in each iterative printing.

6. The method of claim 5, wherein, the print image is shifted by an integer multiple of a nozzle pitch between adjacent nozzles of the nozzle unit in each iterative printing, and printed.

7. An inkjet image forming apparatus comprising:
a print medium transferring unit to transfer a print medium in a first direction;
a printhead which includes a nozzle unit corresponding to at least a width of the print medium, is installed along a second direction, and prints a print image by ejecting ink onto the print medium; and
a control unit to generate a first control signal to synchronize operations of the print medium transferring unit and the printhead so that the print image is shifted at least once in a width direction of the print medium and printed on the print medium when identical data corresponding to the print image is iteratively printed on a plurality of print media.

8. The inkjet image forming apparatus of claim 7, further comprising:
a printing environment information unit to store printing environment information corresponding to a predetermined printing environment when printing according to the predetermined printing environment,
wherein the control unit generates a second control signal to shift and print the print image on the print medium according to the printing environment information stored in the printing environment information unit.

9. The inkjet image forming apparatus of claim 7, wherein the control unit generates a second control signal so that ink droplets ejected from different nozzles in each shifting operation are deposited within a shifting allowable range on the print medium.

10. The inkjet image forming apparatus of claim 9, wherein the shifting allowable range is bounded by a margin of the print medium so that the print image is not printed on the margin of the print medium.

11. The inkjet image forming apparatus of claim 7, wherein the control unit generates a third control signal to shift the print image in the width direction of the print medium on the print medium and to print the print image on the print medium in each iterative printing.

12. The inkjet image forming apparatus of claim 11, wherein the control unit generates a third control signal to shift the print image by an integer multiple of a nozzle pitch between adjacent nozzles of the nozzle unit in each iterative printing.

13. An image-shift printing method for an inkjet image forming apparatus that includes a printhead having a nozzle unit corresponding to at least a width of a print medium and iteratively prints identical data on a plurality of print media, the method comprising:
longitudinally moving the printhead at least once in iterative printing; and
forming and printing a print image within a shifting allowable range on the print media using the moved printhead.

14. The method of claim 13, further comprising:
inputting a printing environment,
wherein the longitudinally moving of the printhead at least once in iterative printing comprises moving the printhead according to the printing environment.

15. The method of claim 13, wherein the longitudinally moving of the printhead at least once during iterative printing comprises moving the printhead by an integer multiple of a nozzle pitch between adjacent nozzles of the nozzle unit in each iterative printing.

16. The method of claim 13, wherein the shifting allowable range is bounded by a margin of the print medium so that the print image is not printed on the margin of the print medium.

17. An inkjet image forming apparatus, comprising:
a print medium transferring unit to transfer a print medium in a first direction;
a printhead which includes a nozzle unit corresponding to a width of the print medium, and is installed along a second direction, to print a print image by ejecting ink onto the print medium;
a carriage including the printhead;
a carriage moving unit to move the carriage in the second direction; and
a control unit to generate a first control signal to synchronize operations of the printhead and the carriage moving unit so that the print image is formed within a shifting allowable range on the print medium after the printhead is longitudinally moved at least once.

18. The inkjet image forming apparatus of claim 17, further comprising:
a printing environment information unit to store printing environment information corresponding to a predetermined printing environment when printing according to the predetermined printing environment,
wherein the control unit generates a second control signal to move the printhead according to the printing environment information stored in the printing environment information unit.

19. The inkjet image forming apparatus of claim 17, wherein the control unit generates a second control signal to move the printhead by an integer multiple of a nozzle pitch between adjacent nozzles of the nozzle unit in each iterative printing.

20. The inkjet image forming apparatus of claim 17, wherein the shifting allowable range is bounded by a margin of the print medium so that the print image is not printed on the margin of the print medium.

21. The inkjet image forming apparatus of claim 17, wherein the carriage moving unit comprises:
a carriage moving motor;
carriage moving rollers, one of which is connected to the carriage moving motor and other one of which is connected to a main frame; and
a carriage moving belt which is connected to the carriage and supported by the carriage moving rollers, and moves the carriage in the second direction.

22. The inkjet image forming apparatus of claim 17, wherein the carriage moving unit comprises:
a guide rod which is connected to the carriage and extends along the second direction; and
a driving unit to move the guide rod in the second direction.

23. The inkjet image forming apparatus of claim 22, wherein the driving unit comprises:
a driving motor including a gear;
a connection gear whose outer circumference has gear teeth to mesh with the gear of the driving motor and whose inner circumference has a female gear; and
a lead screw to mesh with the female gear of the connection gear.

24. The inkjet image forming apparatus of claim 22, wherein the driving unit comprises a piezoelectric actuator.

25. The inkjet image forming apparatus of claim 17, wherein the carriage moving unit comprises an adjusting portion in contact with the carriage to move the carriage in the second direction.

26. The inkjet image forming apparatus of claim 25, wherein the adjusting portion comprises:
an eccentric cam which is rotatably installed on the main frame in contact with the carriage; and
a driving source to rotate the eccentric cam.

27. The inkjet image forming apparatus of claim 25, further comprising:
a bias portion to bias the carriage moved by the adjusting portion toward an original position of the carriage.

28. The inkjet image forming apparatus of claim 27, wherein the bias portion comprises:
an elastic member installed between the main frame and the carriage.

29. An image forming apparatus, comprising: a print unit disposed on a print medium path along a first print medium and a second print medium; and
a control unit to control the print unit to be in a first position with respect to the first print medium when a first image is printed, and to be in a second position with respect to the second print medium when a second image is printed on the second print medium.

30. The image forming apparatus of claim 29, wherein the first image is the same as the second image.

31. The image forming apparatus of claim 29, wherein the first print medium and the second print medium are disposed on a same location of the print medium path.

32. The image forming apparatus of claim 29, further comprising:
a print medium transferring unit to transfer the first print medium and the second print medium along the print medium path,
wherein the first position is different from the second position with respect to the print medium feeding path.

33. The image forming apparatus of claim 29, wherein the first print medium and the second print medium have a same size.

34. The image forming apparatus of claim 29, wherein the first image is printed on the first print medium and spaced-apart from a center of the first print medium by a first distance, and the second image is printed on the second print medium and spaced-apart from a center of the second print medium by a second distance.

35. The image forming apparatus of claim 34, wherein the first image and the second image are the same, and the center of the first print medium and the center of the second print medium are the same.

36. The image forming apparatus of claim 29, further comprises:
a frame on which the print unit is movably installed, and to include a print medium feeding path along which the first print medium and the second print medium are fed; and
a moving unit installed on the frame to move the print unit with respect to the print medium feeding path.

37. The image forming apparatus of claim 36, wherein the moving unit comprises:
a lead screw to move the print unit to the first position and the second position with respect to the print medium feeding path.

38. The image forming apparatus of claim 36, wherein the moving unit comprises:
a cam to move the print unit with respect to the print medium feeding path.

39. The image forming apparatus of claim 29, wherein:
the print unit comprises a print head having a plurality of nozzles; and
the plurality of nozzles are moved with respect to the print medium path so that the first image and the second image are printed using different ones of the plurality of nozzles.

40. The image forming apparatus of claim 29, wherein the first print medium and the second print medium have a common reference axis, and the first image and the second image are deviated from the common reference axis by a first distance and a second distance, respectively.
